(19) United States
(12) Patent Application Publication
(10) Pub. No.: US 2010/0021800 A1
(43) Pub. Date: Jan. 28, 2010

(54) CARBON CATHODES FOR FLUORIDE ION STORAGE

(76) Inventors: Rachid YAZAMI, Los Angeles, CA (US); Isabelle DAROLLES, Pasadena, CA (US)

Correspondence Address: GREENLEE WINNER AND SULLIVAN P C, 4875 PEARL EAST CIRCLE, SUITE 200, BOULDER, CO, 80301, US

(21) Appl. No.: 12/509,306

(22) Filed: Jul. 24, 2009

Related U.S. Application Data
(60) Provisional application No. 61/135,860, filed on Jul. 24, 2008.

(51) Int. Cl. H01M 6/14; H01M 4/58; H01M 4/36

(52) U.S. Cl. 429/50; 429/218.1; 429/220; 429/219; 429/199; 977/948

(57) ABSTRACT

The invention provides fluoride ion host electrodes for use in electrochemical cells. These electrodes include carbon nanomaterials having a curved multilayered structure and a film or particles of a metal-based material. The metal-based material may react with fluorine and may be a transition metal such as silver. The invention also provides electrochemical cells in which the fluoride host electrode serves as at least one electrode of the cell.

### CROSS-REFERENCE TO RELATED APPLICATIONS

This application claims the benefit of U.S. Provisional Application No. 61/135,860, filed Jul. 24, 2008, which is hereby incorporated by reference to the extent not inconsistent with the disclosure herein.

### BACKGROUND OF THE INVENTION

A typical battery includes a positive electrode (cathode during discharge), a negative electrode (anode during discharge) and an electrolyte. The electrolyte contains ionic species that are the charge carriers. Electrolytes in batteries can be of several different types: (1) pure cation conductors (e.g., beta Alumina conducts with Na⁺ only); (2) pure anion conductors (e.g., high temperature ceramics conduct with O⁻ or O²⁻ anions only); and (3) mixed ionic conductors: (e.g., some Alkaline batteries use a KOH aqueous solution that conducts with both OH⁻ and K⁺, whereas some lithium ion batteries use an organic solution of LiPF₆ that conducts with both Li⁺ and PF₆⁻). During charge and discharge electrodes exchange ions with electrolyte and electrons with an external circuit (a load or a charger).

There are two basic types of electrode reactions.

1. Cation based electrode reactions: In these reactions, the electrode captures or releases a cation Y⁺ from electrolyte and an electron from the external circuit:

Electrode+Y⁺+e⁻→Electrode(Y).

Examples of cation based electrode reactions include: (i) carbon anode in a lithium ion battery: 6C+Li⁺+e⁻→LiC₆ (charge); (ii) lithium cobalt oxide cathode in a lithium ion battery: 2Li_{0.5}CoO₂+Li⁺+e⁻→2LiCoO₂ (discharge); (iii) Ni(OH)₂ cathode in rechargeable alkaline batteries: Ni(OH)₂→NiOOH+H⁺+e⁻ (charge); (iv) MnO₂ in saline Zn/MnO₂ primary batteries: MnO₂+H⁺+e⁻→HMnO₂ (discharge).
2. Anion based electrode reactions: In these reactions, the electrode captures or releases an anion X⁻ from electrolyte and an electron from the external circuit:

Electrode+X⁻→Electrode(X)+e⁻

Examples of anion based electrode reactions include: (i) Cadmium anode in the Nickel-Cadmium alkaline battery: Cd(OH)₂+2e⁻→Cd+2OH⁻ (charge); and (ii) Magnesium alloy anode in the magnesium primary batteries: Mg+2OH⁻→Mg(OH)₂+2e⁻ (discharge).

Many batteries are either of pure cation-type or mixed ion-type chemistries. Lithium ion batteries are an example of pure cation-type chemistry. The electrode half reactions and cell reactions for a typical lithium ion battery are:
Carbon anode:
6C+Li⁺+e⁻→LiC₆ (charge)
lithium cobalt oxide cathode:
2Li_{0.5}CoO₂+Li⁺+e⁻→2LiCoO₂ (discharge)
cell reaction:
2LiCoO₂+6C→2Li_{0.5}CoO₂+LiC₆ (charge)
2Li_{0.5}CO₂+LiC₆→2LiCoO₂+6C (discharge)

Dual graphite mixed ion-type cells have been described in which the anion intercalates into the positive graphite electrode and lithium intercalates into the negative graphite electrode when the cells are charged. Seel and Dahn report on PF₆⁻ anion intercalation in a dual graphite cell with a LiPF₆-based electrolyte (2000, J. Electrochem. Soc., 147(3), 892-898)

US Patent Application Publication US 2009/0029237 describes an anion-type electrochemical cell comprising a positive electrode; a negative electrode; and an electrolyte provided between the positive electrode and the negative electrode, wherein the electrolyte is capable of conducting anion charge carriers. The positive electrode and negative electrode comprise different anion host materials that reversibly exchange anion charge carriers with the electrolyte during charging or discharging of the electrochemical cell. During discharge, reduction half reactions occurring at the positive electrode result in release of anion charge carriers from the positive electrode to the electrolyte. The anion charge carriers may be fluoride ions (F⁻¹).

A variety of battery electrodes are known to the art, several of which incorporate graphite or other forms of carbon. Metal coating of the carbonaceous electrode materials has also been reported in some cases. US Patent Application Publication US 2003/0138698A1 reports a carbon active material for a lithium secondary battery comprising a thin film or cluster layer of a metal or metal oxide coated onto the surface of the carbon at a thickness of 1-300 nm. WO 2005/069412 reports an electrode comprising carbon nanotubes or carbon nanofibers and sulfur or metal nanoparticles as a binder. WO 2008/033827 reports an electrode comprising an array of vertically aligned carbon nanofibers separated by interstices, wherein the carbon nanofibers are coated by continuous metal coatings.

### SUMMARY OF THE INVENTION

In one aspect, the invention provides an electrode for use in an electrochemical cell. In an embodiment, the electrode comprises an electrode mixture comprising a plurality of carbon nanomaterials having a curved multilayered structure and a metal-based film or metal-based particles deposited onto at least some of the nanomaterials. The structure of the carbon nanomaterials may be substantially ordered. Suitable metals, include but are not limited, to transition metals such as silver. The metal-based material may be pure metal, a metal alloy, or a metal compound. Suitable metal compounds can include, but are not limited to, metal fluorides, metal oxides, or metal oxide-fluorides. In an embodiment, the metal-based material is a pure metal or metal alloy.

In an embodiment, the electrode is a fluoride ion (F⁻) host electrode and the electrode mixture contains a fluoride ion host material. As used herein, the term “fluoride ion host material” refers to a material capable of accommodating fluoride ions. In this context, accommodating includes insertion of fluoride ions into the host material, intercalation of fluoride ions into the host material and/or reaction of fluoride ions with the host material. In an embodiment, the electrode is a fluoride ion (F⁻) intercalation electrode. In an embodiment, the metal-based material reacts with fluoride ions and/or fluorine.

Incorporation of a suitable metal-based coating on at least some of the carbon nanomaterials in the electrode mixture can improve the capacity of the electrochemical cell. In different embodiments, the improvement in cell capacity may be from 50 to 100%, or 50% to 150%. Without wishing to be bound by any particular belief, the presence of the metal may facilitate the accommodation reaction when the electrode is used as an anion host electrode.

In another embodiment, the invention provides an electrode for an electrochemical cell comprising a plurality of carbon nanomaterials having a substantially ordered curved multilayered structure, wherein the carbon nanomaterials have been subjected to a particle beam irradiation prior to their use in an electrochemical cell. Without wishing to be bound by any particular belief, the structural damage caused by particle beam irradiation may facilitate the accommodation reaction when the electrode is used as an anion host electrode.

In another embodiment, the invention provides an electrode for an electrochemical cell comprising a plurality of carbon nanomaterials having a substantially ordered curved multilayered structure and a metal film or metal particles deposited onto at least some of the nanomaterials, wherein the carbon nanomaterials have been subjected to particle beam irradiation prior to their use in an electrochemical cell.

In another aspect, the invention provides electrochemical cells comprising the electrodes of the invention. Electrochemical cells of the present invention are versatile and include primary and secondary cells useful for a range of important applications including use in portable electronic devices.

In an embodiment, the invention provides an electrochemical cell comprising:

a) a first electrode comprising a current collector and an electrode mixture, the electrode mixture comprising a plurality of carbon nanomaterials having a substantially ordered curved multilayered structure; a metal-based film or metal-based particles deposited onto at least some of the nanomaterials, and a polymeric binder material, wherein at least a portion of the electrode mixture is in electrical contact with the current collector;
b) a second electrode; and
c) a nonaqueous electrolyte provided between said first and second electrodes, said electrolyte being capable of conducting fluoride ions (F⁻); wherein said first electrode reversibly exchanges said fluoride ions with said electrolyte during charging or discharging of said electrochemical cell. In an embodiment, the first electrode is the positive electrode and the second electrode is the negative electrode.

During discharge of the electrochemical cell, reduction half reactions occurring at the positive electrode result in release of anion charge carriers from the positive electrode to the electrolyte. During charging, oxidation half reactions occurring at the positive electrode result in accommodation of anion charge carriers from the electrolyte to the positive electrode.

Use of fluoride ion charge carriers in electrochemical cells provides a number of benefits. First, the low atomic mass (18.998 AMU), high electron affinity (−328 kJ mol⁻¹) of fluorine and about 6V redox voltage stability window (from −3.03V vs. NHE to +2.87V vs. NHE) of the fluoride ion (F⁻) can result in electrochemical cells having high voltage, high energy densities and high specific capacities. Second, fluoride ion has a small atomic radius and, thus, can participate in reversible insertion and/or intercalation reactions in many electrode host materials that do not result in significant degradation or significant structural deformation of the electrode host material upon cycling in secondary electrochemical cells. This property can result in secondary fluoride ion electrochemical cells having a large cycle life (e.g., greater than or equal to about 500 cycles). Third, fluoride ion is stable with respect to decomposition at electrode surfaces for a useful range of voltages (−3.03V vs. NHE to +2.87V vs. NHE), thereby providing enhanced performance stability and safety of electrochemical cells.

In another aspect, the present invention provides a method for making an electrochemical cell comprising the steps of: (i) providing a positive electrode of the present invention; (ii) providing a negative electrode; and (iii) providing an electrolyte between the positive electrode and the negative electrode; the electrolyte capable of conducting anion charge carriers; wherein the positive electrode is capable of reversibly exchanging the anion charge carriers with the electrolyte during charging or discharging of the electrochemical cell.

In another aspect, the present invention provides a method for generating an electrical current, the method comprising the steps of: (i) providing an electrochemical cell; the electrochemical comprising: a positive electrode of the present invention; a negative electrode; and an electrolyte provided between the positive electrode and the negative electrode; the electrolyte capable of conducting anion charge carriers; wherein the positive electrode is capable of reversibly exchanging the anion charge carriers with the electrolyte during charging or discharging of the electrochemical cell; and (ii) discharging the electrochemical cell. The method of this aspect of the present invention may further comprise the step of charging the electrochemical cell. In some embodiments of this aspect of the present invention the anion charge carrier is fluoride ion (F⁻).

### BRIEF DESCRIPTION OF THE FIGURES

FIGS. 1A-1D: SEM images of pure MWNF powder after a chemical silver deposit (C/Ag approximately 100).

FIGS. 2A-2D: SEM images of pure MWNF powder after a chemical silver deposit (C/Ag approximately 6.25)

FIG. 3: X-ray diffraction patterns of MWNF powder before and after coating by Ag.

FIGS. 4A-4C: SEM images of an irradiated silver coated MWNF (unused cathode) (wt %=Ag 11%, MWNFs 62%, ABG 5%, PVDF 22%).

FIGS. 5A and 5B: SEM image (FIG. 5A) and EDS analysis (FIG. 5B) of an irradiated silver coated MWNFs film (unused cathode).

FIG. 6: X-ray powder diffraction pattern for a MWNF film electrochemically coated by Ag (unused cathode) (wt %=Ag 11%, MWNFs 64%, PVDF 25%)

FIG. 7: Schematic of assembly of the CR2016 coin cell.

FIG. 8: 2nd cycle of cyclic voltammogram of various cathode films: MWNF film, MWNF_Ag 1% film, MWNF_Ag 4% film, and MWNF_Ag 16% film in 1M LiPF6+1M LiF PC/EC/DMC electrolyte (Sweep rate=0.3 mV/s).

FIG. 9A: Normalized charge plot obtained from integration of the cyclic voltamograms presented in FIG. 8. (C rate=C/1.5).

FIG. 9B: Normalized discharge plot obtained from integration of the cyclic voltamograms presented in FIG. 8. (C rate=C/1.5).

FIG. 9C: Charge and discharge curves for a MWNF Ag 1% film for different cycle numbers.

FIG. 9D: Charge and discharge curves for a MWNF Ag 4% film for different cycle numbers.

FIG. 10: Cyclic voltammogram of a Ag coated MWNFs cathode film in 1M LiPF₆+1M LiF PC/EC/DMC electrolyte (Sweep rate=0.3 mV/s).

FIG. 11: Charge and discharge plots obtained from integration of the cyclic voltammograms presented in FIG. 10 (C rate=C/1.5).

FIG. 12: Cyclic voltammograms of an Ag coated MWNFs cathode film in 1M LiPF6+1M LiF PC/EC/DMC electrolyte (Sweep rate=0.05 mV/s).

FIG. 13: Charge and discharge plots obtained from integration of the cyclic voltamogram presented in FIG. 12 (C rate=C/9) and comparison with similar plots for C rate of 1.5.

FIG. 14: Voltage vs. time of an irradiated MWNF film (without silver coating) using 1M LiPF6+1M LiF/PC+EC+DMC.

FIG. 15: Specific capacity as a function of cycle number of an irradiated MWNF film (without silver coating) using 1M LiPF₆+1M LiF/PC+EC+DMC.

FIG. 16: Voltage vs. time of an Ag coated irradiated MWNF film using 1M LiPF₆+1M LiF/PC+EC+DMC.

FIG. 17: Specific capacity as a function of cycle number of an Ag coated irradiated MWNF film using 1M LiPF₆+1M LiF/PC+EC+DMC.

FIGS. 18A-E: SEM images of an silver coated irradiated MWNF film used as cathode (several cycles, charged to 5.3 V)

FIGS. 19A-D: SEM image (FIG. 19A) and EDS analysis (FIGS. 19B-D) of a silver coated irradiated MWNF film used as cathode (several cycles, charged to 5.3 V).

FIGS. 20A-C: SEM image (FIG. 20A) and EDS analysis (FIGS. 20B-C) of a silver coated irradiated MWNF film used as cathode (several cycles, charged to 5.3 V).

FIG. 21: X-ray powder diffraction patterns for an irradiated MWNF film coated by Ag, before (unused cathode) and after charging to 5.3V.

FIG. 22A: X-ray diffraction data for a MWNF film coated by Ag, after charging to 5.3V.

FIG. 22B: Possible structures for fluorine intercalation at stage 2 and 3.

FIG. 23: X-ray diffraction data for a MWNF film coated by Ag, before use and after discharge to 3.5 V.

FIGS. 24-28 show XPS patterns for various MWNF films used as cathodes for the specified binding energy regions and testing conditions.

FIG. 29 shows surface species as identified from XPS patterns for the specified testing conditions

### DETAILED DESCRIPTION OF THE INVENTION

Referring to the drawings, like numerals indicate like elements and the same number appearing in more than one drawing refers to the same element. In addition, hereinafter, the following definitions apply:

“Standard electrode potential” (E°) refers to the electrode potential when concentrations of solutes are 1M, the gas pressures are 1 atm and the temperature is 25 degrees Celsius. As used herein standard electrode potentials are measured relative to a standard hydrogen electrode.

“Anion charge carrier” refers to a negatively charged ion provided in an electrolyte of an electrochemical cell that migrates between positive and negative electrodes during discharge and charging of the electrochemical cell. Anion charge carriers useful in electrochemical cells of the present invention include, but are not limited to, fluoride ions (F⁻), and the following other anions:

BF₄⁻, PF₆⁻, AsF₆⁻, SbF₆⁻, BiF₆⁻, AlF₄⁻, GaF₄⁻, InF₄⁻, TlF₄⁻, SiF₅⁻, GeF₅⁻, SnF₅⁻, PbF₅⁻, SF₇⁻, IF₆⁻, ClO₄⁻, CF₃SO₃⁻, (CF₃SO₂)₂N⁻ and C₄F₉SO₃⁻

“Intercalation” refers to refers to the process wherein an ion inserts into a host material to generate an intercalation compound via a host/guest solid state redox reaction involving electrochemical charge transfer processes coupled with insertion of mobile guest ions, such as fluoride ions. Major structural features of the host material are preserved after insertion of the guest ions via intercalation. In some host materials, intercalation refers to a process wherein guest ions are taken up with interlayer gaps (e.g., galleries) of a layered host material. Examples of intercalation compounds include fluoride ion intercalation compounds wherein fluoride ions are inserted into a host material, such as a layered fluoride host material or carbon host material.

The term “electrochemical cell” refers to devices and/or device components that convert chemical energy into electrical energy or electrical energy into chemical energy. Electrochemical cells have two or more electrodes (e.g., positive and negative electrodes) and an electrolyte, wherein electrode reactions occurring at the electrode surfaces result in charge transfer processes. Electrochemical cells include, but are not limited to, primary batteries, secondary batteries and electrolysis systems. General cell and/or battery construction is known in the art, see e.g., U.S. Pat. Nos. 6,489,055, 4,052,539, 6,306,540, Seel and Dahn J. Electrochem. Soc. 147(3) 892-898 (2000).

The term “capacity” is a characteristic of an electrochemical cell that refers to the total amount of electrical charge an electrochemical cell, such as a battery, is able to hold. Capacity is typically expressed in units of ampere-hours. The term “specific capacity” refers to the capacity output of an electrode, per unit weight. Specific capacity is typically expressed in units of ampere-hours kg⁻¹. The specific capacity may be expressed based on the unit weight of active material in the battery.

The term “discharge rate” refers to the current at which an electrochemical cell is discharged. Discharge current can be expressed in units of ampere. Alternatively, discharge current can be normalized to the rated capacity of the electrochemical cell, and expressed as C/(X t), wherein C is the capacity of the electrochemical cell, X is a variable and t is a specified unit of time, as used herein, equal to 1 hour.

“Current density” refers to the current flowing per unit electrode area.

“Active material” refers to the material in an electrode that takes part in electrochemical reactions which store and/or delivery energy in an electrochemical cell.

As used herein, electrode refers to an electrical conductor where ions and electrons are exchanged with electrolyte and an outer circuit. “Positive electrode” and “cathode” are used synonymously in the present description and refer to the electrode having the higher electrode potential in an electrochemical cell (i.e. higher than the negative electrode). “Negative electrode” and “anode” are used synonymously in the present description and refer to the electrode having the lower electrode potential in an electrochemical cell (i.e. lower than the positive electrode). Cathodic reduction refers to a gain of electron(s) of a chemical species, and anodic oxidation refers to the loss of electron(s) of a chemical species.

“Electrode potential” refers to a voltage, usually measured against a reference electrode, due to the presence within or in contact with the electrode of chemical species at different oxidation (valence) states.

“Electrolyte” refers to an ionic conductor which can be in the solid state, the liquid state (most common), a gel state, or more rarely a gas (e.g., plasma).

“Cation” refers to a positively charged ion, and “anion” refers to a negatively charged ion.

In an embodiment, the invention provides an electrode for use in an electrochemical cell, the electrode comprising a current collector and an electrode mixture comprising a plurality of carbon nanomaterials having a substantially ordered curved multilayered structure, a metal-based film or metal-based particles deposited onto at least some of the nanomaterials and a polymeric binder, wherein at least a portion of the electrode mixture is in electrical contact with the current collector

As used herein, a carbon nanomaterial has at least one dimension that is between one nanometer and one micron. In an embodiment, at least one dimension of the nanomaterial is between 2 nm and 1000 nm. For carbon nanotubes, nanofibers, nanowhiskers or nanorods the diameter of the tube, fiber, nanowhiskers or nanorod falls within this size range. For carbon nanoparticles, the diameter of the nanoparticle falls within this size range. Carbon nanomaterials suitable for use with the invention include materials which have total impurity levels less than 10% and carbon materials doped with elements such as boron, nitrogen, silicon, tin and phosphorous.

Carbon nanomaterials suitable for use with the invention have multiple carbon layers prior to fluorination. In an embodiment, the carbon layers are curved; such as concentric or scroll-like layers. For multiwalled nanotubes, the layers are formed by the graphene layers which make up the walls of the nanotube. For multilayered nanoparticles, the layers are formed by multilayered fullerenes.

As used herein, the term “nanotube” refers to a tube-shaped discrete fibril typically characterized by a diameter of typically about 1 nm to about 20 nm. In addition, the nanotube typically exhibits a length greater than about 10 times the diameter, preferably greater than about 100 times the diameter. The term “multi-wall” as used to describe nanotubes refers to nanotubes having a layered structure, so that the nanotube comprises an outer region of multiple continuous layers of ordered atoms and a distinct inner core region or lumen. The layers are disposed substantially concentrically about the longitudinal axis of the fibril. For carbon nanotubes, the layers are graphene layers. Carbon nanotubes have been synthesized in different forms as Single-, Double- and Multi-Walled Carbon Nanotubes noted SWCNT, DWCNT and MWCNT respectively. The diameter size ranges between about 2 nm in SWCNTs and DWCNTs to about 20 nm in MWCNTs. In an embodiment, the MWNT used in the invention have a diameter greater than 5 nm, greater than 10 nm, between 10 and 20 nm, or about 20 nm.

Multi-walled carbon nanotubes can be produced by catalytic chemical vapor deposition (CVD). In an embodiment, carbon nanotubes produced by CVD are heat treated to improve their structural and micro textural characteristics before undergoing the fluorination process of the invention. In particular, the carbon nanotubes are heated to a sufficiently high temperature so that the graphene layers become substantially straight and well aligned with the tube axis. In an embodiment, the MWCNT are heated to produce a substantially well ordered structure. As used herein, a carbon nanostructure is substantially well ordered when it has at least one peak in its X-ray diffraction pattern, which peak 1) appears in the angular area comprised between 24.5 degrees and 26.6 degrees in the diffraction angle 2 theta, using a copper monochromatic radiation, and 2) has a full width at half maximum of less than 4 degrees in the 2 theta diffraction angle.

As used herein, carbon nanofibers refer to carbon fibers having a diameter greater than 20 nm and less than 1000 nm. In different embodiments, the carbon nanofibers used in the invention are between 20 and 1000 nm, between 40 and 1000 nm or between 80 and 350 nm. Carbon nanofibers having concentric carbon layers similar to those of multi-walled nanotubes can be produced by catalytic chemical vapor deposition and heat treatment. In particular, the CVD-produced carbon nanofibers are heated to a sufficiently high temperature so that the carbon layers become substantially straight and well aligned with the fiber axis. In different embodiments, the carbon nanofibers are heated to a temperature greater than greater than 1800° C., or greater than 2500° C. to produce a substantially well ordered structure.

As is known in the art, vapor-grown carbon fibers (VGCF) with larger diameters (e.g. 10 microns) can also be produced by catalytic chemical vapor deposition. These fibers can have a structure of layer-like growth rings which lie concentrically on top of each other (Endo, M., 1988, Chemtech, 568-576). VGCF having a diameter of one micron or greater are not intended by be encompassed by the term “carbon nanomaterials” as used in the present invention.

Carbon nanoparticles can be thought of as structures related to large, rather imperfect multilayered fullerenes (Harris, P., 1999, “Carbon Nanotubes and Related Structures”, Cambridge University Press, Cambridge, p. 103). One form of carbon nanoparticle is referred to as a “carbon onion.” When fully formed, carbon onions appear highly perfect in structure and have few obvious defects (Harris 1999). Carbon onions have been formed with diameters in excess of 5 nm (Harris 1999). Nasibulin et al. report formation of carbon onions between 5 nm and 30 nm (Nasimbulin, A. G., et al., 2005, Colloid J., 67(1), 1-20), while Sano et al. report formation of carbon onions between 4 and 36 nm (Sano, N. et al, 2002, J. Appl. Phys., 92(5), 2783). In different embodiments, the multi-walled carbon nanoparticles used in the invention have a diameter greater than 5 nm, greater than 10 nm, greater than 20 nm, between 5 and 35 nm, or between 10 and 30 nm.

One form of carbon nanorods, grown by electron cyclotron resonance chemical vapor deposition, was reported by Woo et al. The filamentous carbon did not form a hollow tube. High resolution transmission electron microscopy was reported to show crystalline walls, with the graphene layers being somewhat disordered and slanted about the rod axis. The average distance between the graphene layers was reported to be larger than that in MWCNT (Woo, Y. et al., 2003 J. Appl. Phys. 94(10, 6789).

Carbon whiskers, also known as graphite whiskers, are known to the art. These materials appear to have a scroll-like structure made up of an essentially continuous graphitic structure (Harris 1999).

The carbon nanostructures may be subjected to particle beam irradiation prior to their use in an electrochemical cell. Suitable forms of particle beam irradiation include, but are not limited to, electron beam irradiation, ion irradiation (including hydrogen ion/proton beam irradiation), neutron irradiation, gamma-ray irradiation and x-ray irradiation. It is known to the art that particle irradiation can produce defects in carbon materials. In an embodiment, carbon structure following particle beam irradiation contains point defects, but the outer walls or layers of the carbon nanostructure retain a graphene layer structure, although the average interlayer spacing may increase. In an embodiment, X-ray diffraction analysis of the irradiated carbon nanomaterials still shows a distinct peak in angular area comprised between 24.5 degrees and 26.6 degrees in the diffraction angle 2 theta, using a copper monochromatic radiation. In an embodiment, the irradiation type, energy and dose is selected in order to retain at least a partial of the graphene layer structure. Ishaq et al. (2009, Materials Letters, 63 (2009) 1505-1507) describe irradiation energies and doses at which a graphite to amorphous structure transformation of multiwalled carbon nanotubes occurs under proton beam irradiation.

In another embodiment, the carbon nanostructures may be subjected to chemical treatment prior to their use in an electrochemical cell. In an embodiment, the chemical treatment may involve contacting the carbon nanostructures with a strong acid. Such treatments are known in the art for opening the ends of nanotube structures.

In an embodiment, the carbon nanostructures are not in the form of an array.

In an embodiment, a metal-based film, particles, or a combination thereof are attached at least some of the multi-walled carbon nanomaterials of the electrode mixture. The coating provided by the film or particles may or may not be uniform. In an embodiment, the coating is not uniform over a given nanomaterial or from one nanomaterial to another. For example, metal particles may be deposited on one portion of a given multi-walled nanotube, but may not be present on another portion of the nanotube. For a metal film, the film need not be continuous. As another example, the metal coating need not be uniform through the thickness of the electrode mixture.

In an embodiment, the metal is a transition metal. In an embodiment, the transition metal is selected from the group consisting of Cu, Ag, Au, Pt, Hg and combinations thereof. In another embodiment, the metal is selected from the group consisting of Cu, Ag, and Au and combinations thereof. In an embodiment, the metal is a noble metal. In an embodiment, the metal is Ag. The metal may also be selected from group IIIA of the periodic table, such as Al, In or combinations thereof. The metal may also be selected from group IVA of the periodic table, such as Sn, Pb or combinations thereof.

In an embodiment, a metal or nonmetal-based material may be attached to the carbon nanomaterials, the metal or nonmetal being selected so that it reacts with fluorine. In an embodiment, the metal or non-metal reacts with fluorine to form a fluoride compound. This fluoride compound may or may not be stable under the conditions present in the electrochemical cell.

In another embodiment, the metal or nonmetal is selected to form a high oxidation state in a fluoride which is unstable. Without wishing to be bound by any particular belief, during the charge process the following reactions may occur (illustrated for a metal):

M+nF−<=>MFn+ne− (1)

MFn+xC<=>MFn−1+(CxF) (2)

with formation of MFn, an unstable metal fluoride, allowing the transfer of F anions from electrolyte to the MWNF cathode

Elements which are believed to form a high oxidation state in a fluoride include Cu, Ag, Au, V, Cr, Mn, Co, Ni, Tc, Ru, Rh, Pd, Re, Os, Ir, Pt, Ce, Pr, Nd, Tb, Dy, Np, Pu, Am, Bp, Cf, Es, As, Bi, S, Se, Te, and Cl. In an embodiment, the element is a transition metal. In another embodiment, the element is a lanthanide or actinide. in another embodiment, the element is nonmetallic, such as As, Bi, S, Se, Te, and Cl.

A variety of techniques for metal deposition are known to the art. These include, but are not limited to, precipitation, electrodeposition, chemical vapor deposition, and physical vapor deposition. In different embodiments the average thickness of the film or diameter of the particles is less than 1 micron, less than 500 nm, less than 200 nm, or less than 50 nm. In other embodiments, the film thickness or particle diameter is from 1 nm to 500 nm, 1 nm to 200 nm, 1 nm to 100 nm, or 10 nm to 150 nm.

In different embodiments, the average atomic ratio percentage of metal to carbon (100*moles M/moles C) or molar percentage of metal (100*moles M/(moles M+moles C) is from 1 to 80%, 1 to 70%, 1 to 60%, 1 to 40%, from 1 to 30%, or from 5 to 40% . When the metal coating is not uniform, the local atomic ratio of metal to carbon may vary within the electrode mixture. Similar ranges can apply to nonmetallic elements.

In other embodiments, the average weight ratio percentage (100*wt M/wt C) or weight percentage (100*wt M/(wt M+wt C)) of metal is from 1% to 95%, from 1 to 75 wt %, from 5 to 75 wt %, or from 5 to 60 wt %. Similar ranges can apply to nonmetallic elements.

In an embodiment, the polymeric binder is at least partially fluorinated. Exemplary binders thus include, without limitation, poly(ethylene oxide) (PEO), poly(vinylidene fluoride) (PVDF), a poly(acrylonitrile) (PAN), poly(tetrafluoroethylene) (PTFE), and poly(ethylene-co-tetrafluoroethylene) (PETFE). In different embodiment, the binders represent about 1 wt. % to about 30 wt. %, or from 5 wt % to 25 wt % of the electrode mixture.

In another embodiment, the electrode mixture further comprises a metal compound. The metal compound may be a metal oxide, a metal fluoride, or a combination of metal with oxygen and fluorine. In an embodiment, the compound is a metal salt. In an embodiment, the metal salt is a metal fluoride.

Metal-based materials may be present in both metallic and compound form in the electrode composition. For example, the metal coating may include metallic silver, and Ag and/or AgF₂. In different embodiments, the average atomic ratio percentage of metal to carbon (M/C) is from 1 to 80%, 1 to 70%, 1 to 60%, 1 to 50%, 1 to 40%, from 1 to 30%, or from 5 to 40%, considering the metal both in metallic form and in compound form.

Electrodes of the present invention may further comprises a conductive diluent, such as acetylene black, carbon black, powdered graphite, coke, carbon fiber, and metallic powder.

In different embodiments, the preferred weight percentage of the carbon nanomaterial may be at least 20 wt %, 30 wt %, 40 wt %, or 50 wt %, from 50 wt % to 75 wt % or from 50 wt % to 90 wt %.

Positive and negative electrodes of the present invention may be provided in a range of useful configurations and form factors as known in the art of electrochemistry and battery science, including thin electrode designs, such as thin film electrode configurations. Electrodes are manufactured as disclosed herein and as known in the art, including as disclosed in, for example, U.S. Pat. Nos. 4,052,539, 6,306,540, 6,852,446. For some embodiments, the electrode is typically fabricated by depositing a slurry of the electrode mixture and a liquid carrier on the electrode current collector, and then evaporating the carrier to leave a coherent mass in electrical contact with the current collector. Typically, the slurry formed upon admixture of the foregoing components is then deposited or otherwise provided on a conductive substrate to form the electrode. A particularly preferred conductive substrate is aluminum, although a number of other conductive substrates can also be used, e.g., stainless steel, titanium, platinum, gold, and the like.

In an embodiment, the invention provides a fluoride ion (F⁻) host electrode for use in an electrochemical cell. A “fluoride ion host electrode” includes a fluoride ion host material capable of accommodating fluoride ions. In this context, “accommodation” of anion charge carriers includes capture of anion charge carriers by the host material, insertion of anion charge carriers into the host material, intercalation of anion charge carriers into the host material and/or chemical reaction of anion charge carriers with the host material. Accommodation includes alloy formation chemical reactions, surface chemical reactions with the host material and/or bulk chemical reactions with the host material. In an embodiment, the fluoride ion acceptor electrode is capable of intercalation of fluoride ions into the carbon nanomaterials present in the electrode.

In another aspect, the invention provides an electrochemical cell comprising:

a) a positive electrode of the invention;
b) a negative electrode; and
c) a nonaqueous electrolyte provided between said positive electrode and said negative electrode, said electrolyte being capable of conducting fluoride ions (F⁻); wherein said positive electrode reversibly exchanges said fluoride ions with said electrolyte during charging or discharging of said electrochemical cell

In the context of this description, the term “exchange” refers to release or accommodation of anion charge carriers at the electrodes via oxidation and reduction reactions during discharge or charging of the electrochemical cell.

In an embodiment, an electrolyte of an electrochemical cell of the present invention comprises a solvent and a fluoride salt, wherein the fluoride salt is at least partially present in a dissolved state in the electrolyte so as to generate fluoride ions in the electrolyte. Electrolytes in electrochemical cells of the present invention include fluoride salts having the formula: MFₙ, wherein M is a metal, and n is an integer greater than 0. In some embodiments, for example, M is an alkali metal, such as Li, Na, K or Rb, or M is an alkaline earth metal, such as Mg, Ca or Sr. In some embodiments, the concentration of the fluoride salt in the electrolyte is selected from the range of about 0.1M to about 2.0M.

Electrolytes for anionic electrochemical cells of the present invention, including fluoride ion electrochemical cells, include aqueous electrolytes and nonaqueous electrolytes. Useful electrolyte compositions for anionic electrochemical cells preferably have one or more of the following properties. First, electrolytes for some applications preferably have a high ionic conductivity with respect to the anion charge carrier, for example for fluoride ions. For example, some electrolytes useful in the present invention comprise solvents, solvent mixtures and/or additives providing conductivity for an anion charge carrier, such as a fluoride ion anion charge carrier, greater than or equal to 0.0001 S cm⁻¹, greater than or equal to 0.001 S cm⁻¹, or greater than or equal to 0.005 S cm⁻¹. Second, electrolytes for some embodiments are capable of dissolving an electrolyte salt, such as a fluoride salt, so as to provide a source of anion charge carriers at a useful concentration in the electrolyte. Third, electrolytes of the present invention are preferably stable with respect to decomposition at the electrodes. For example, electrolytes of an embodiment of the present invention comprises solvents, electrolyte salts, additives and anion charge carriers that are stable at high electrode voltages, such as a difference between positive and negative electrode voltages equal to or greater than about 4.5V. Fourth, electrolytes of the present invention preferable for some applications exhibit good safety characteristics, such as flame retardance.

Optionally, electrolytes of the present electrochemical cells include one or more additives. In an embodiment, the electrolyte comprises an anion receptor, such as fluoride ion anion receptors capable of coordinating fluoride ions of a fluoride salt, and/or a cation receptor, for example a cation receptor capable of coordinating metal ions of a fluoride salt. Useful anion receptors in the present invention include, but are not limited to, fluorinated boron-based anion receptors having electron withdrawing ligands, such as fluorinated boranes, fluorinated boronates, fluorinated borates, phenyl boron-based compounds and aza-ether boron-based compounds. Useful cation receptors for electrolytes of electrochemical cells of the present invention include, but are not limited to, crown ethers, lariat ethers, metallacrown ethers, calixcrowns (e.g., calyx(aza)crowns), tetrathiafulvalene crowns, calixarenes, calix[4]arenediquinoes, tetrathiafulvalenes, bis(calixcrown)tetrathiafulvalenes, and derivatives thereof. In some embodiments, electrolytes of the present invention comprise other inorganic, organic or gaseous additives. Additives in electrolytes of the present invention are useful for: (i) enhancing conductivity of the anion charge carrier, (ii) decreasing flammability, (iii) enhancing electrode wetting, (iv) decreasing electronic conductivity, and (v) enhancing the kinetics of anion charge carriers at the electrodes, for example by enhancing formation of a solid electrolyte interface (SEI) or by reducing the buildup of discharge products. In an embodiment, the electrolyte comprises a Lewis acid or a Lewis base such as, but not limited to

BF₄⁻, PF₆⁻, AsF₆⁻, SbF₆⁻, BiF₆⁻, AlF₄⁻, GaF₄⁻, InF₄⁻, TlF₄⁻, SiF₅⁻, GeF₅⁻, SnF₅⁻, PbF₅⁻, SF₇⁻, IF₆⁻, ClO₄⁻, CF₃SO₃⁻, (CF₃SO₂)₂N⁻, C₄F₉SO₃⁻ and NR₄⁺ (R═H or an alkyl group CₙH₂ₙ₊₁ n=integer).

### STATEMENTS REGARDING INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

When a group of substituents is disclosed herein, it is understood that all individual members of that group and all subgroups, including any isomers, enantiomers, and diastereomers of the group members, are disclosed separately. When a Markush group or other grouping is used herein, all individual members of the group and all combinations and subcombinations possible of the group are intended to be individually included in the disclosure. When a compound is described herein such that a particular isomer, enantiomer or diastereomer of the compound is not specified, for example, in a formula or in a chemical name, that description is intended to include each isomers and enantiomer of the compound described individual or in any combination. Additionally, unless otherwise specified, all isotopic variants of compounds disclosed herein are intended to be encompassed by the disclosure. For example, it will be understood that any one or more hydrogens in a molecule disclosed can be replaced with deuterium or tritium. Isotopic variants of a molecule are generally useful as standards in assays for the molecule and in chemical and biological research related to the molecule or its use. Methods for making such isotopic variants are known in the art. Specific names of compounds are intended to be exemplary, as it is known that one of ordinary skill in the art can name the same compounds differently.

Many of the molecules disclosed herein contain one or more ionizable groups [groups from which a proton can be removed (e.g., —COOH) or added (e.g., amines) or which can be quaternized (e.g., amines)]. All possible ionic forms of such molecules and salts thereof are intended to be included individually in the disclosure herein. With regard to salts of the compounds herein, one of ordinary skill in the art can select from among a wide variety of available counterions those that are appropriate for preparation of salts of this invention for a given application. In specific applications, the selection of a given anion or cation for preparation of a salt may result in increased or decreased solubility of that salt.

Every formulation or combination of components described or exemplified herein can be used to practice the invention, unless otherwise stated.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

### EXAMPLES

### Example 1

### Fabrication of Silver-Coated MWNF Electrodes via Chemical Deposition

Chemical deposition was carried out by mixing multi-walled carbon nanofibers (MWNFs) powder (regular (non-irradiated) MWNF, diameter approximately 150 nm/aspect ratio of 12, MER, Tucson, Ariz.)), Ag NO₃ and NH₄F in 25 mL double distilled water. The mixture was stirred at 60° C. for 15 minutes. The mixture leads to a paste which is dried under vacuum at 120° C. overnight.

Deposition

3 various silver coated MWNFs powder were made with different C/Ag molar ratios:

Ag 1% (C/Ag=about 100) by mixing 0.4 g AgNO3+2.5 g NH4F+3 g MWNFs;
Ag 4% (C/Ag=about 25) by mixing 0.8 g AgNO3+3 g NH4F+1.5 g MWNFs; and
Ag 16% (C/Ag=about 6.25) by mixing 3.2 g AgNO3+6 g NH₄F+1.5 g MWNFs

For 1 mol % silver, weight ratio percents (based on (wt C/wt Ag)*100) are 8 wt % Ag and 92 wt % C. For 4 mol % silver, the equivalent weight ratio percents are about 25 wt % Ag and 75 wt % C. For 16 mol % silver, the equivalent weight ratio percents are about 53 wt % Ag and 47 wt % C.

Surface Analysis (SEM, XRD)

The morphology of the silver coated MWNFs was examined by using a scanning electron microscope (SEM, LEO 1550 VP). The surface analysis of the cathode films was performed using a INCA Energy 300 X-ray Energy Dispersive Spectrometer (EDS) system.

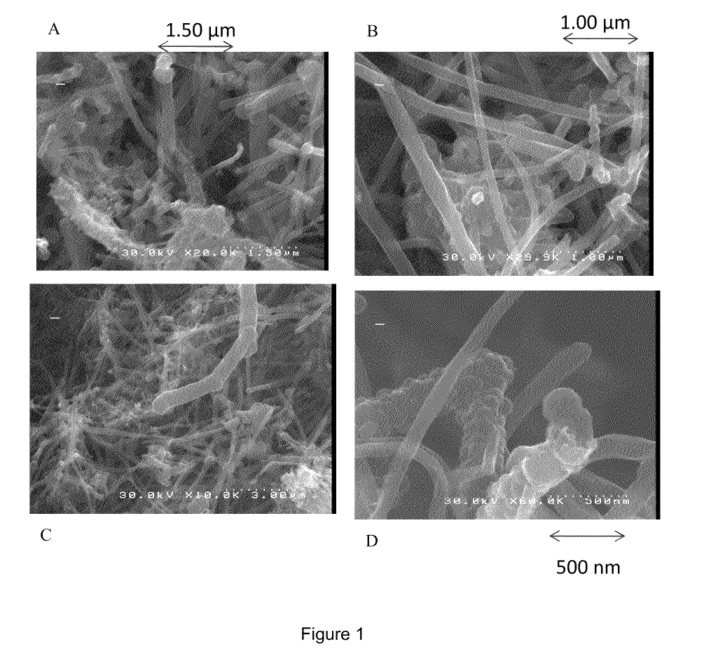

FIG. 1 shows SEM images of silver coated MWNF (Ag 1%). A silver layer is observed coating the fibers but the layer covers partially the fibers and only some of them.

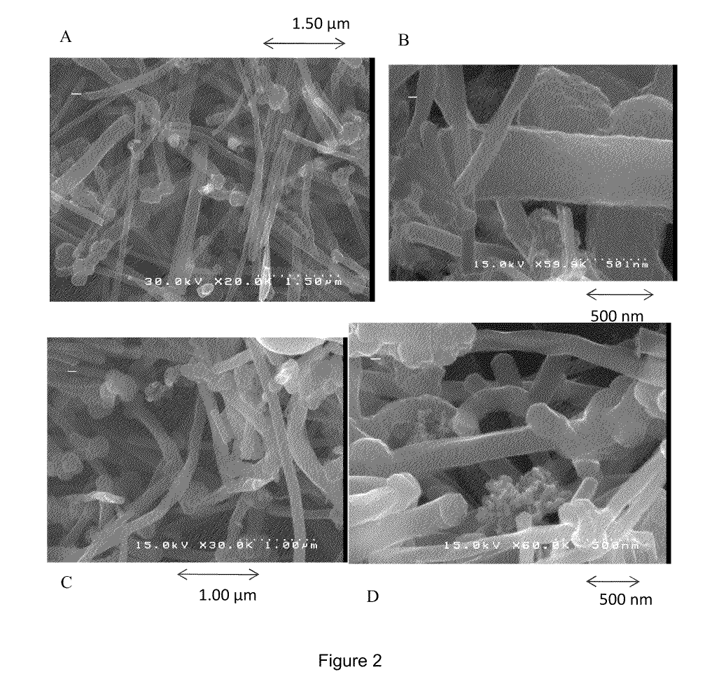

FIG. 2 shows SEM images of MWNF after silver coating (Ag 16%). With a higher amount of silver, there are still many fibers not entirely covered. It seems that there are preferential sites on the nanofiber surface where silver is deposited spontaneously. By adding the amount of Ag can lead to an increase of the deposit thickness instead of complete coverage of the surface area.

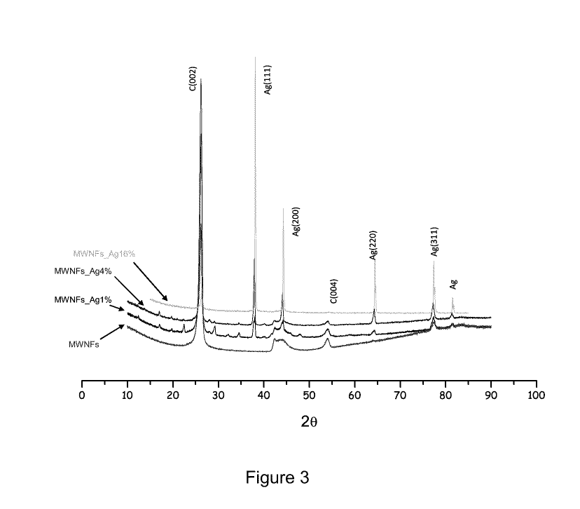

The X-ray diffraction (XRD) measurements were performed using a Philips Expert Pro instrument using 45 kV and 40 mA setting and a copper target. We hence have for Kα1: λ_{Cu}=1.540598 Å as the x-ray source wavelength. FIG. 3 shows the diffraction patterns obtained for MWNFs powder before and after coating by Ag. The patterns confirm presence of Ag. We observe, as expected, peaks due to the presence of silver. Furthermore, silver peak intensity increases as a function of Ag/C ratio. In FIG. 3, the lower spectrum is for the uncoated MWNFs, and the spectra are in order of Ag concentration. The crystallite sizes determined from XRD were 37 nm for Ag 1%, 67 nm for Ag 4% and 105 nm for Ag 16%.

Electrode Fabrication

The electrode film was prepared by mixing silver-coated multiwalled carbon nanofibers (MWNF) powder (MER, Tucson, Ariz.) and polyvinylidene fluoride (PVDF, Kynar® grade 2801, Arkema, King of Prussia, Pa.) as a binder at the weight ratio of 75:25 in acetone solution. The mixture was then spread out on an aluminum foil (˜20 μm thick) to form the electrode. The MWNF based films obtained using this method were between 100 and 120 microns thick and weigh between 4 and 8 mg/cm². The electrodes were cut (surface=1.4 cm², 7-15 mg), then dried at 110° C. under vacuum before being transferred in the glove box.

For Ag 1 mol %, the film composition is 6 wt % Ag+69 wt % MWNF+25 wt % PVDF. For Ag 4 mol %, the film composition is 19 wt % Ag+56 wt % MWNF+25 wt % PVDF. For Ag 16 mol %, the film composition is 43 wt % Ag+32 wt % MWNF+25 wt % PVDF.

### Example 2

### Fabrication of Silver-Coated MWNF Electrodes via Electrochemical Deposition

Electrode Fabrication for Electrodeposition

Proton irradiated multiwalled carbon nanofibers were prepared by exposing MWNF (diameter approximately 150 nm/aspect ratio of 12, MER, Tucson, Ariz.) to 150 MeV proton irradiation for 60 min. When XRD results for the irradiated and non-irradiated fibers were compared, no peak shifts were observed and no clear increase in the full width at half maximum (FWHM) was observed for peaks at 2theta=26.3°, 2theta=42.4°, 2theta=44°, and 2theta=54.1°. However, comparison of Raman analysis shows a slight peak shift and a decrease in the ratio l(D)/l(G), indicating an increase in the crystallite size.

The cathode film was prepared by mixing proton-irradiated or non-irradiated multiwall carbon nanofibers (MWNF) powder (diameter approximately 150 nm/aspect ratio of 12, MER, Tucson, Ariz.;) and polyvinylidene fluoride (PVDF, Kynar® grade 2801, Arkema, King of Prussia, Pa.) as a binder at the weight ratio of 75:25 in acetone solution. The mixture was then spread out on an aluminum foil (˜20 μm thick) to form the cathode. The MWNF based films obtained using this method were between 100 and 120 microns thick and weighed between 4 and 8 mg/cm². The cathodes were cut (surface=1.4 cm², 7-15 mg), then dried at 110° C. under vacuum before being transferred in the glove box.

Electrodeposition

Ag electrodeposition was carried out using a coin cell. A silver foil was used as reference and counter electrode; an irradiated or non-irradiated MWNF film as working electrode and in between a glass fiber separator soaked with the electrolyte. The electrolyte used was 40 mM AgNO₃+40 mM Co(NO₃)₂ in acetonitrile. A linear sweep voltammetry was carried out (sweep rate=50 mV/s) down to E=−0.75V/Ag and E=−0.75 V/Ag was then held for 20 s. Then, the MWNF film was washed in acetonitrile and dried at 100° C. under vacuum overnight. In order to determine the amount of Ag deposited on surface, the MWNF film was weighed before and after electrodeposition. The thin silver layers covering the electrode film obtained using this method weigh between 1 and 1.3 mg. It leads to a 7-11% Ag coating in wt % (ratio).

Surface Analysis (SEM, XRD)

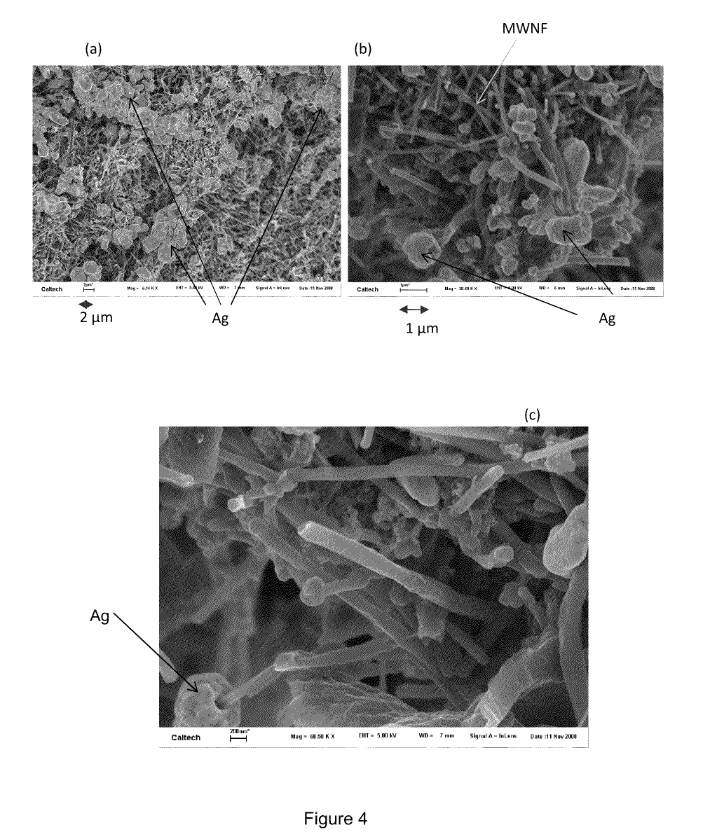

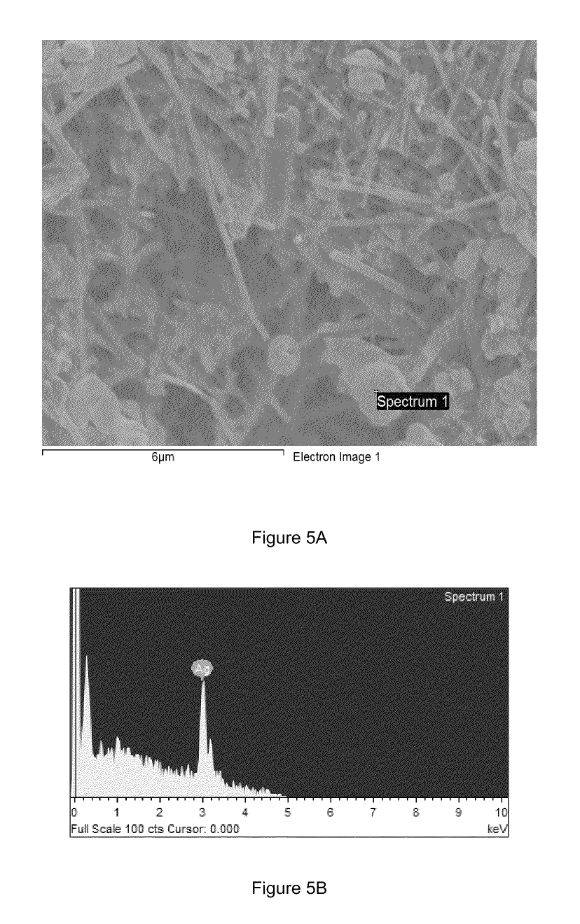

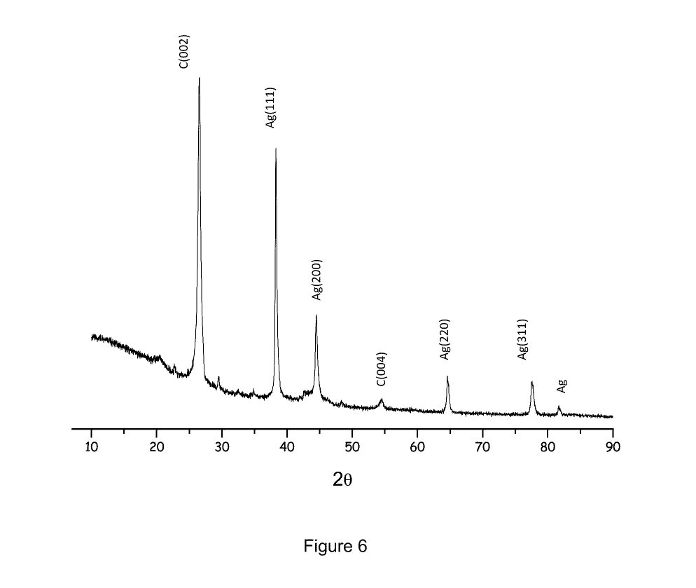

FIG. 4 shows SEM images of a MWNF film after silver coating (Ag 11%). EDS analysis (FIG. 5) and X-Ray diffraction measurements (FIG. 6) confirm the presence of silver after electrodeposition. This method leads to a quite consistent silver deposit but there are still areas of the fibers not covered by silver.

### Example 3

### Electrochemical Measurements with Electrolyte Containing LiF and LiPF₆

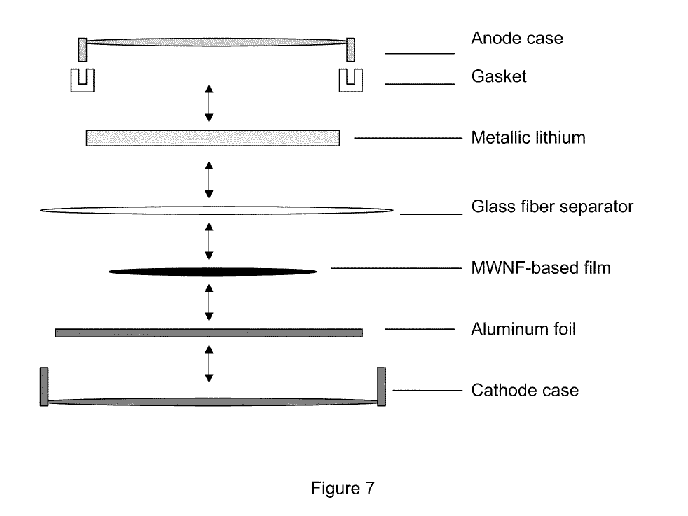

Coin cell assembly was carried out in a glove box under ultra high purity argon gas. The 2016 coin cell type was used, with a diameter of 20 mm and a thickness of 1.6 mm. The cell structure is shown in FIG. 7. Li metal foil (1.5 mm thickness) was used as a counter electrode in the coin cell. A glass fiber separator (Craneglas® 230/19.4, obtained from Crane&Co) was soaked with electrolyte.

The electrolyte was 1M LiPF₆+1M LiF (Alfa Aesar) in ethylene carbonate (EC)/dimethylene carbonate (DMC)/propylene carbonate (PC) (2:2:1 vol %) (Sigma Aldrich). LiPF₆ was used to dissolve the LiF. The water content of the electrolyte measured by an AQ-300 Karl Fischer titrator was about 20 ppm.

Electrochemical Characterization

Several cycles by cyclic voltammetry were performed at high voltages between 3.5V and 5.4V (using a Voltalab PGZ3051).

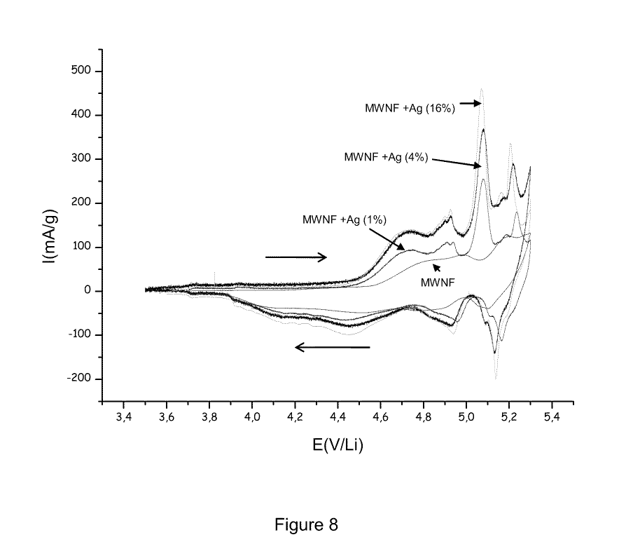

FIG. 8 compares the 2^{nd} cycle obtained for different cathode films in contact with 1M LiPF₆+1M LiF PC/EC/DMC electrolyte. The different films are: uncoated MWNF film (inner loop,), MWNF_Ag 1% film, MWNF_Ag 4% film, and MWNF_Ag 16% film (grey line). The silver coatings were applied via chemical deposition. The sweep rate=0.3 mV/s.

Voltammograms exhibit oxidation and reduction peaks indicating a reversible anion intercalation/deintercalation in stages. In their previous works, Dahn et al. (J. A. Seel and J. R. Dahn, J. Electrochem. Soc., 147, 892 (2000); J. R. Dahn and J. A. Seel, J. Electrochem. Soc., 147, 899 (2000)) have shown the same shape of cyclic voltammograms obtained with a graphite cathode in 2M LiPF₆/EMS electrolyte. They attributed those peaks to PF₆⁻ intercalation and deintercalation into graphite. In our case, however, the data indicates that F⁻ is the species intercalated into MWNF, not PF₆⁻.

FIG. 8, new peaks appeared in oxidation and in reduction when MWNF have been coated by Ag (by chemical deposition). In addition, the charge and discharge peaks intensities have increased showing more reversible features for the anion intercalation/deintercalation processes. Furthermore, an increase of the peaks intensity is observed with an increase of the amount of coated Ag. It is clear that the silver coating improves anion intercalation and increase the reversible capacity.

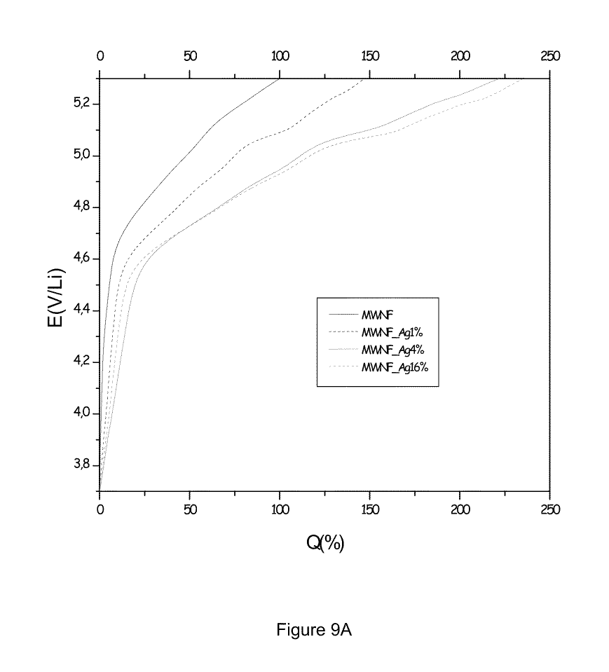

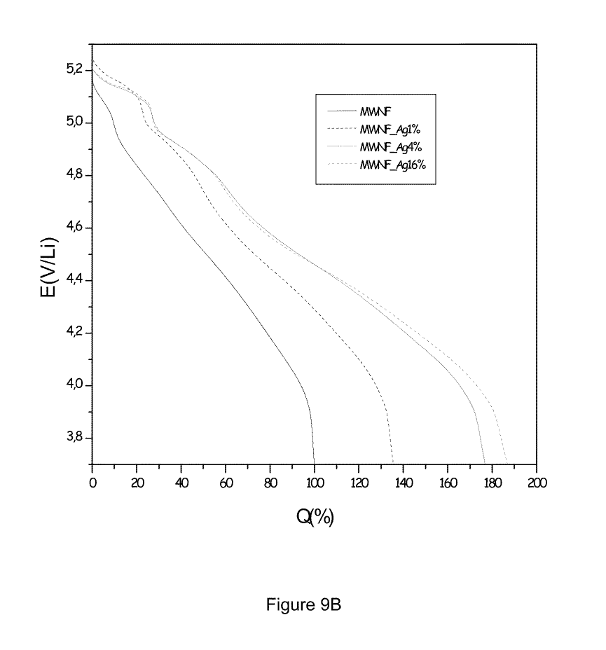

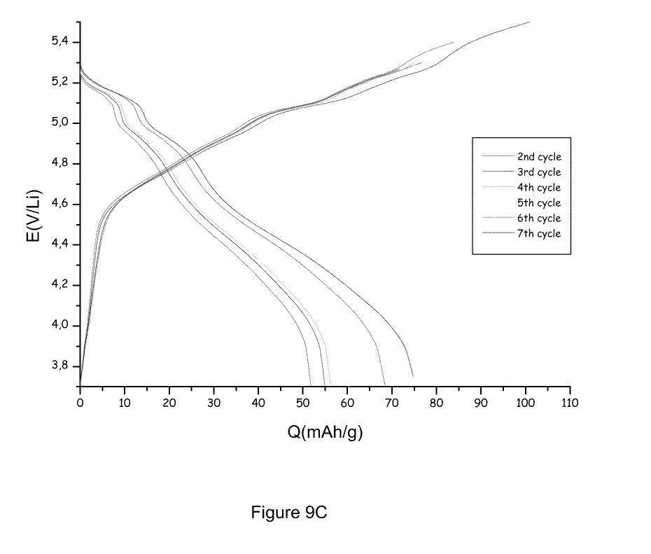

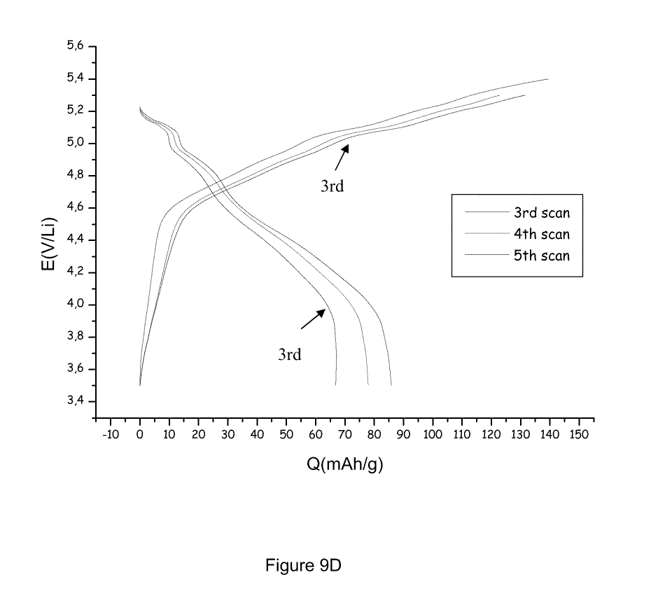

To see these features more easily, the 4 integrated voltammograms have been plotted vs. normalized capacity. FIGS. 9A and 9B, respectively, show the normalized to the uncoated non-irradiated MWNFs charge and discharge curves obtained from the integration of the 2^{nd} cycle of the cyclic voltammetry (MWNF=black line, MWNF_Ag 1%=black dotted line, MWNF_Ag 4%=grey line, MWNF Ag 16%=dotted grey line). We observe, as expected, voltage plateaus in cathodes based on Ag modified MWNF. It suggests that anion is intercalating into the carbon electrode and that staged phases are most likely forming. As expected capacities are higher with Ag coated MWNF films and the capacities increase with the amount of silver.

From the discharge curve we obtained a reversible capacity of 53 mAh/g in the case of pure MWNF film. This capacity has been improved up to about 90% with an Ag 16% coated MWNF film.

FIGS. 9C and 9D, respectively show charge and discharge curves for a MWNF Ag 1% (molar) film and Ag 4% (molar) film for different cycle numbers. In FIGS. 9C and 9D, the discharge capacity increases with increasing cycle number.

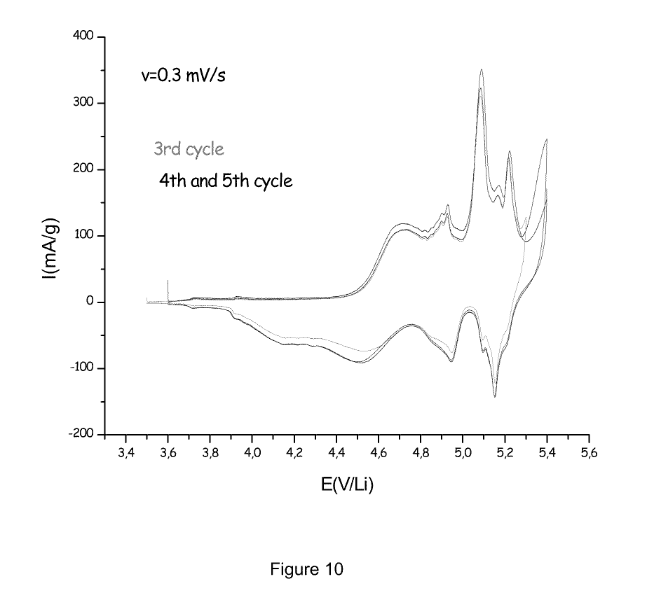

FIG. 10 shows 3 cyclic voltammograms (sweep rate=0.3 mV/s, equivalent to ˜C/1.5 rate) obtained for a cathode including MWNF coated with silver by electrochemical deposition in contact with 1M LiPF₆+1M LiF PC/EC/DMC electrolyte. The composition of the cathode film was 11 wt % Ag+66 wt % MWNFs+23 wt % PVDF. The third cycle is denoted by grey lines, the fourth and fifth cycles by black lines.

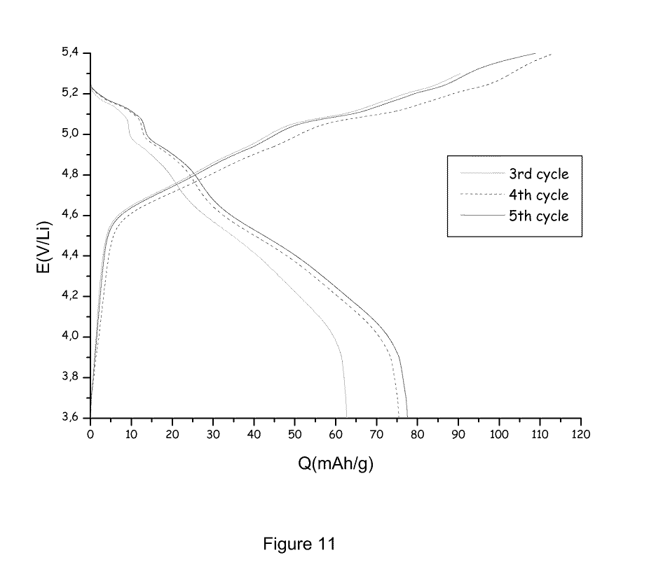

Very well defined current peaks are observed during the charge and discharge processes. The integration of voltammograms results in the charge and discharge plots, showed in FIG. 11. Here again, higher capacity was achieved with an increase of 60% compared to a regular MWNF film (The third cycle is denoted by a grey line, the fourth cycle by a black dotted line, the fifth cycle by a black solid line).

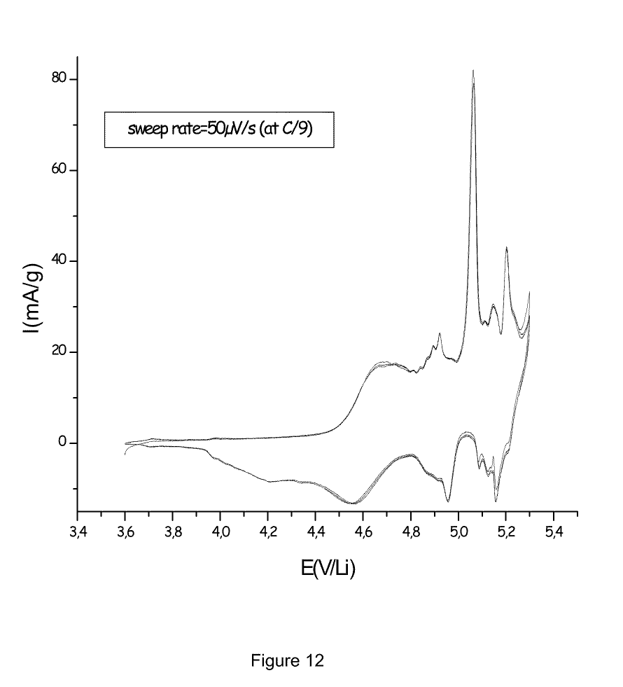

FIG. 12 shows cyclic voltammograms obtained for a cathode including MWNF coated with silver by electrochemical deposition in contact with 1M LiPF₆+1M LiF PC/EC/DMC electrolyte at a lower rate (sweep rate=0.05 mV/s, equivalent to ˜C/9 rate). The composition of the cathode film was 10 wt % silver coated MWNFs (67%)+PVDF (23%)

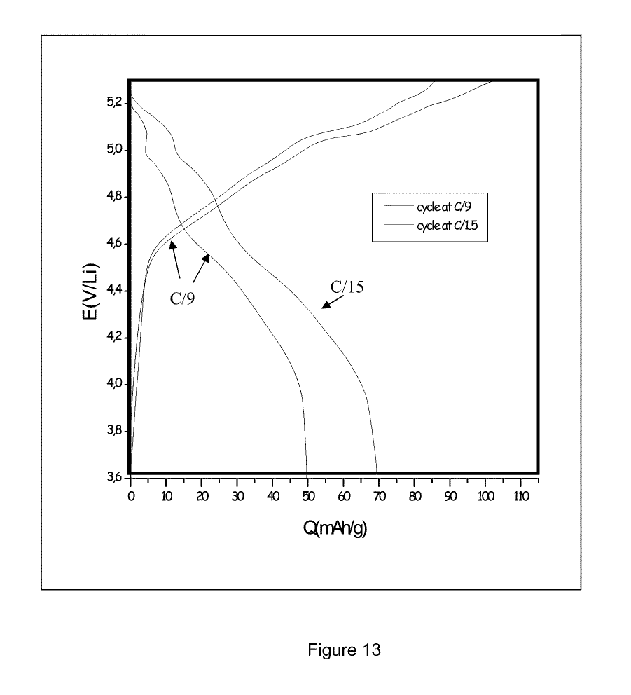

The voltammograms of FIG. 12 exhibit more peaks in oxidation and in reduction than in FIG. 10. The integration of a cyclic voltamogram leading to the charge/discharge plots is shown FIG. 13. At a lower sweep rate, a higher charge capacity is reached whereas the reversible capacity is lower.

Galvanostatic Cycling

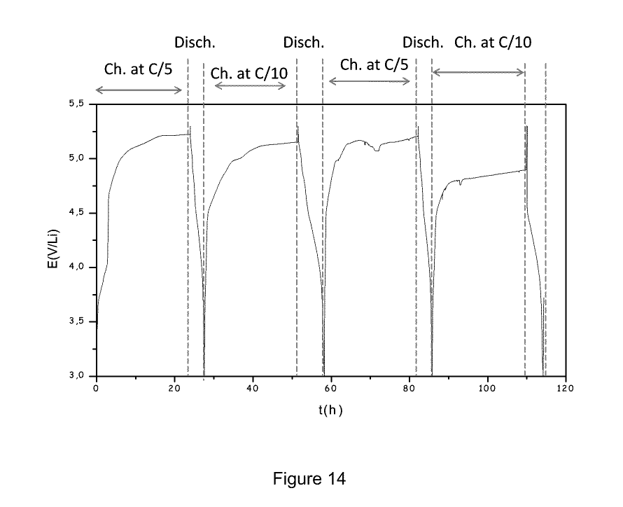

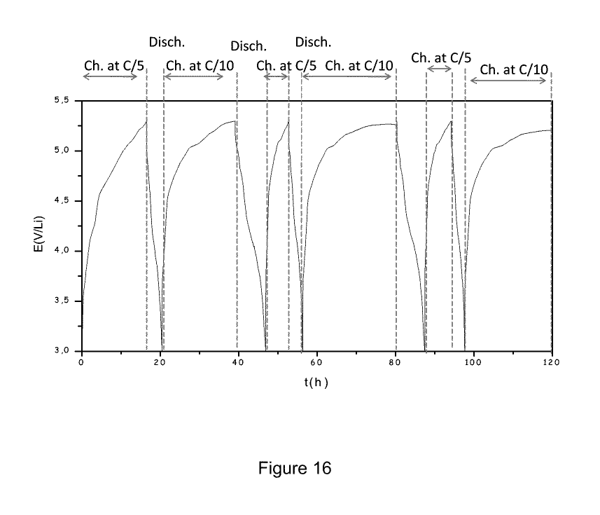

Galvanostatic charge and discharge profiles were achieved in coin cells between voltage limits (3V min.-5.3V max.) a charge/discharge unit (Arbin). An alternation of constant charge and discharge currents corresponding to about C/5 and C/10 according to a theoretical capacity of 120 mAh/g if C₁₈F is achieved. The galvanostatic charge and discharge profiles measured for an irradiated MWNF film (cathode=Irradiated MWNFs 75%+PVDF 25% film) and for an irradiated MWNF film with an electrochemically deposited Ag coating (cathode=75% silver coated irradiated MWNFs+25% PVDF) are respectively shown in FIG. 14 and FIG. 16. The presence of plateaus in the curve suggests that F is intercalating into the carbon electrode and that staged phases are most likely forming. These plateaus are observed in charge and discharge and correspond to the same potential previously shown in cyclic voltammetry. It is clear that the coulombic efficiency is less than one, for the charge time is longer than the discharge time for all cycles, presumably due to irreversible losses probably associated with electrolyte decomposition.

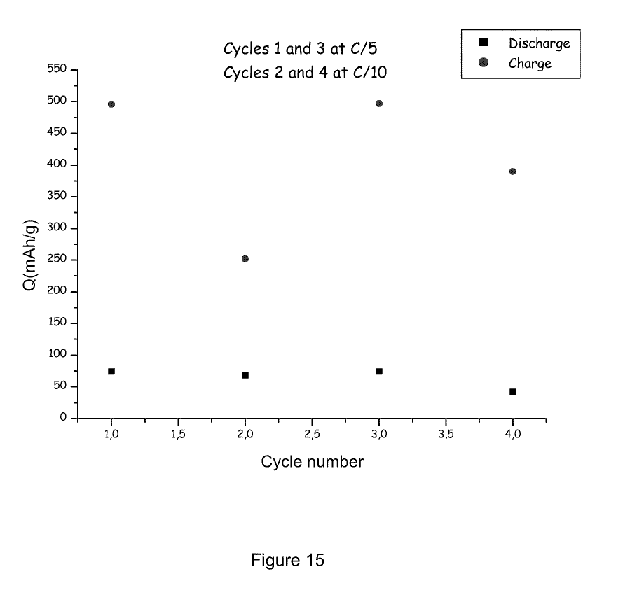

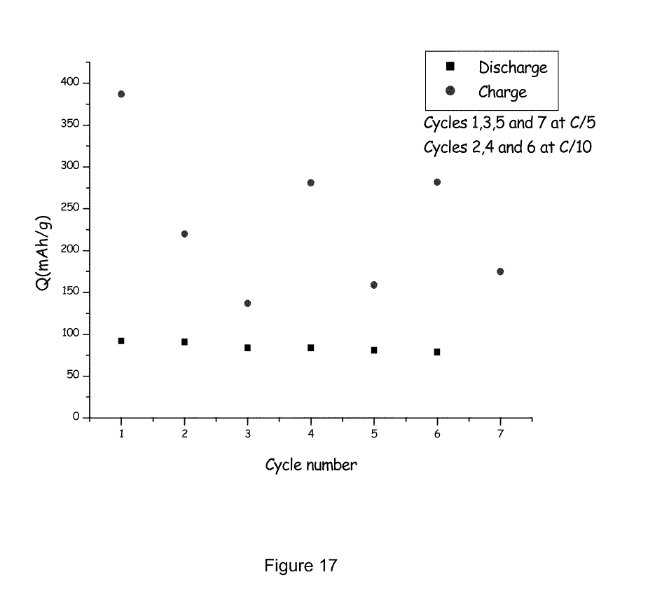

FIG. 15 and FIG. 17 show the variation in charge and discharge capacities as a function of cycle number obtained from FIGS. 14 and 16 respectively. FIGS. 15 and 17 compare performances of an irradiated MWNF film Ag coated or not. Here again, it is clear that the presence of Ag on film leads to a higher reversible capacity. FIG. 15 exhibits a reversible capacity of about 75 mAh/g with an irradiated MWNF film, whereas a reversible capacity of about 100 mAh/g is obtained with an Ag coated irradiated MWNF film (FIG. 17).

Without wishing to be bound by any particular belief, the silver is believed to facilitate intercalation of fluorine into the carbon. The silver may act as a catalyst (not consumed). During the charge process the following reactions may occur:

Ag+F⁻<=>AgF+e− (3)

AgF+F⁻<=>AgF₂+e− (4)

AgF₂+nC<=>AgF+(CₙF) (5)

with formation of AgF, a fluoride ion conductor layer, allowing the transfer of F anions from electrolyte to the MWNF cathode.

Surface Analysis

SEM

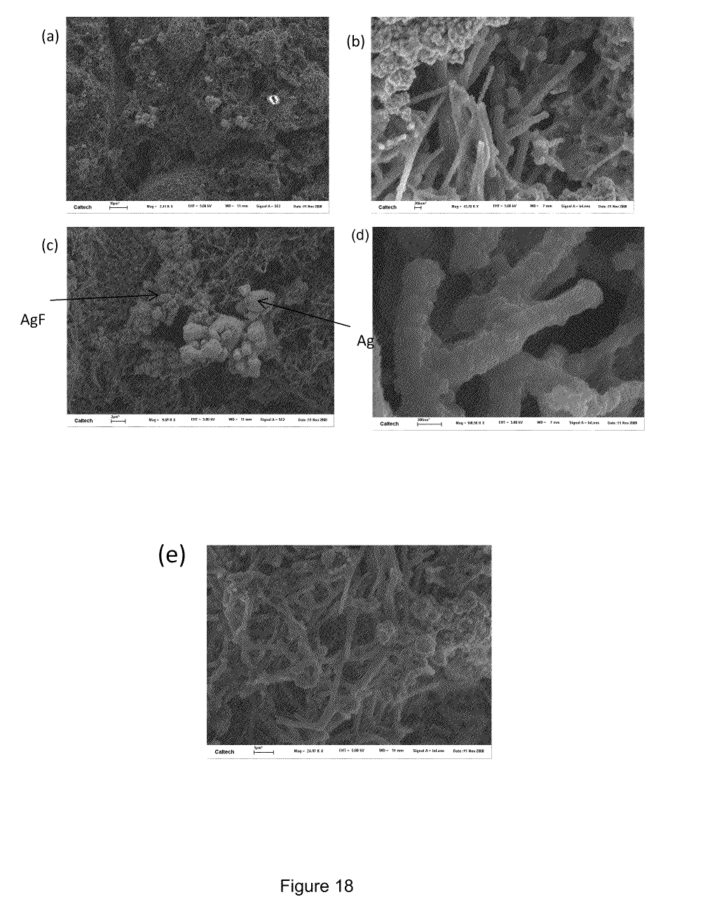

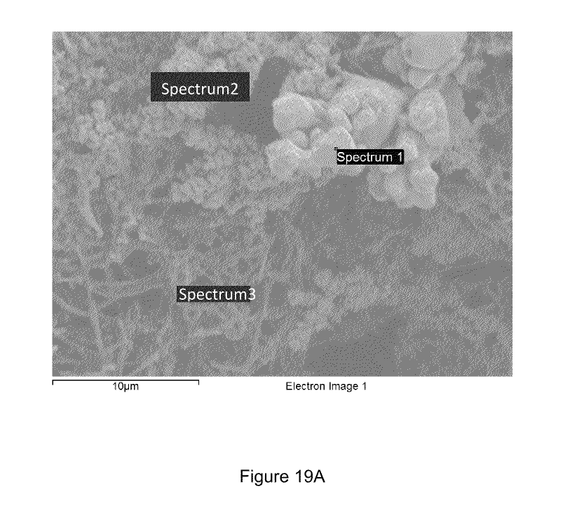

In order to test whether the reaction mechanism proposed above occurs at the positive electrode during charge process, SEM images of an irradiated MWNF film coated by Ag after charging to 5.3V were made. FIG. 18 shows SEM images of an irradiated MWNF film coated by Ag after charging to 5.3V ((wt %=Ag 7%, irradiated MWNFs 65%, ABG 5%, PVDF 23%)

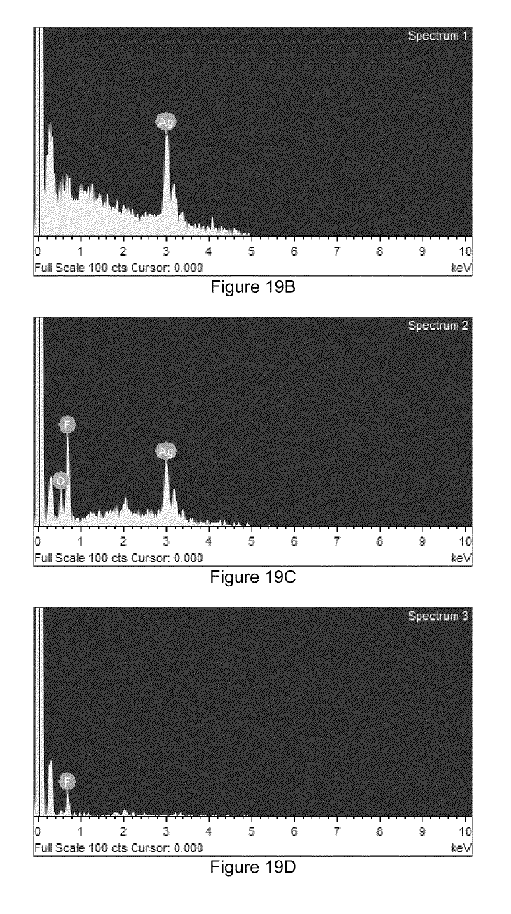

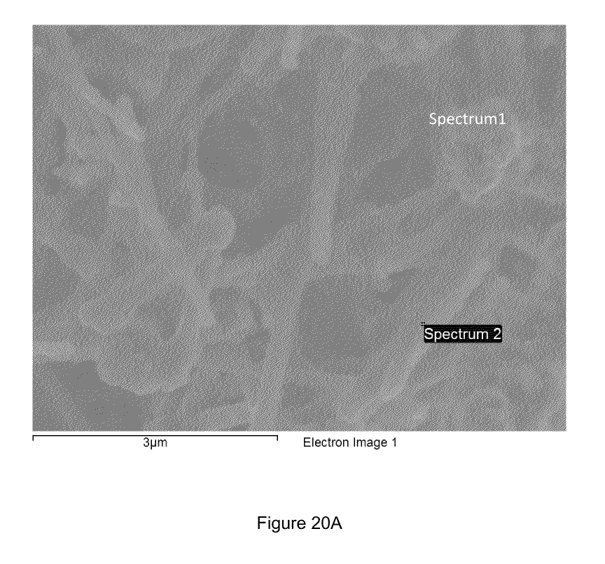

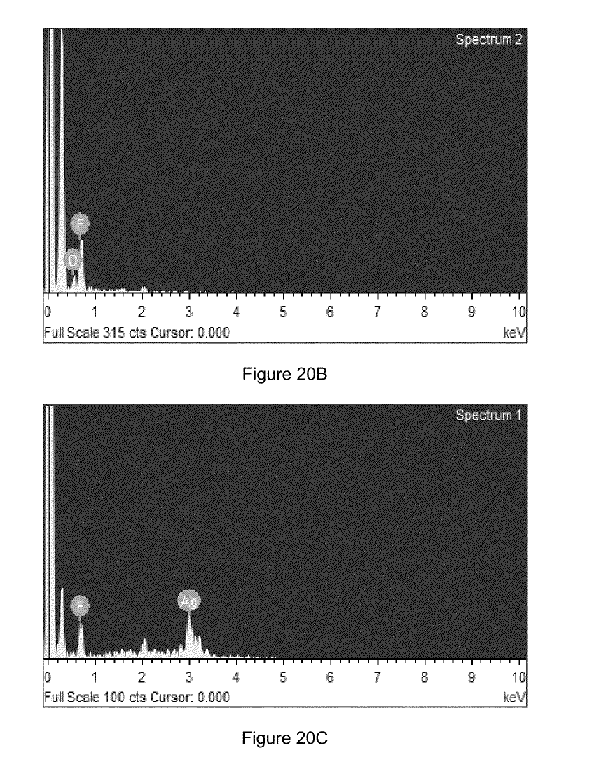

EDS analysis (FIGS. 19 and 20) has revealed that, as expected, both silver and fluoride are present in the area of spectrum 2 in FIG. 19 and in the area of spectrum 1 in FIG. 20, but that both elements are not present over the whole surface. Additional EDS analysis reveals that in some locations the calculated atomic percentage of F and Ag are about 50% (+/−5%). Therefore, it is believed that AgF was formed in at least some locations.

X-Ray Diffraction

To test whether the reaction mechanism occurring at the positive electrode during charge process is anion intercalation, X-ray diffraction was performed on an MWNF film coated by Ag (electrochemical deposit) before and after charging to 5.3V (the electrode composition was 11 wt % Ag, 66 wt % MWNF and 23 wt % PVDF).

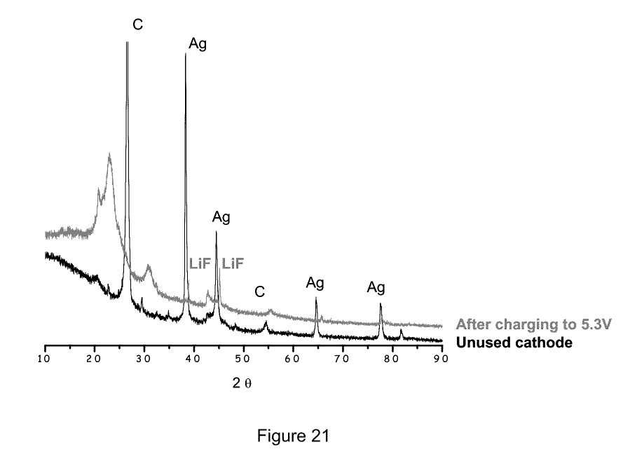

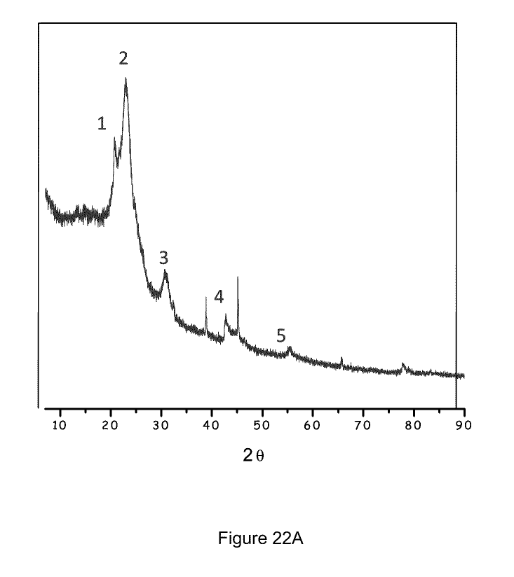

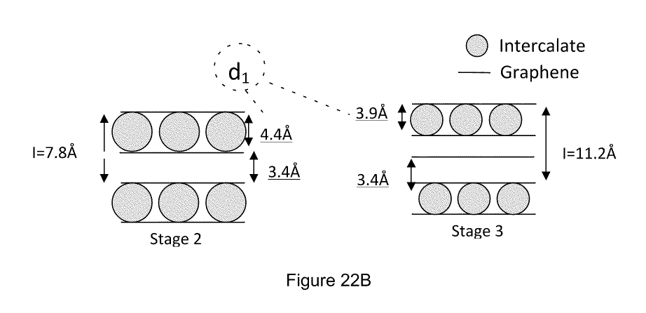

FIG. 21 shows the pattern obtained for the unused and charged electrode. The starting material pattern exhibits peaks corresponding to the graphite phase and to metallic silver. The sharp peak at 26.10 corresponds to the crystallographic plane (002) direction in graphite's hexagonal lattice structure. This corresponds to an interlayer spacing of 3.40 Å.

After charging the cathode to 5.3V, we observe the total disappearance of the graphite (002) peak and silver peaks. No crystalline silver fluoride is observed. But obviously, five new peaks have appeared. The peak at 20.3° can be identified as the (00n) peak of a stage n structure (Ubbelohde and Lewis: Graphite and its compounds, Clarendon Press, Oxford, 1960). Appearance of the (00n+1) peak at 30.4° is a clear indication of staging, that is the presence of F in only every nth space between graphene sheets. Hence, upon charge to 5.3V, appearance of new peaks is associated with the stages of intercalated fluoride ion

We can index these peaks knowing their angular position. By using the following relation:

I=d₁+(n−1)*3.40 Å (6)

we can calculate I for each stage. I is the periodic distance between successive intercalated layer. Table 1 shows X-ray diffraction data for the charged to 5.3V cathode and compares d experimental and theoretical values.

TABLE 1

| Peak | Position. | | d-spacing [Å] | Rel. | Indexation |
|---|---|---|---|---|---|
| No. | [2θ°] | d-spacing [Å] | Calculated Value | Int. [%] | (hkl)-stage n |
| 1 | 20.3 | 4.4 | 4.4 | 56 | CFx(002)-2 |
| 2 | 22.6 | 3.9 | 3.9 | 100 | CFx (003)-3 |
| 3 | 30.4 | 2.9 | 2.9 | 19 | CFx(003)-2 |
| 4 | 42.3 | 2.1 | 2.2 | 15 | CFx (004)-2 |
| 5 | 55.1 | 1.7 | 1.8 | 5 | CFx (005)-2 |

In this case it seems that theoretical and experimental value for each (hkl) plan fit well with a mixture of stage 2 and stage 3. For the c parameters obtained in this study, the gallery spacing for stage 2 and 3 compounds are shown in FIG. 22B. In their work carried out on chemical intercalation of fluorine into natural graphite, Nakajima et al. obtained (001) peaks for stage 1 ionic/semi-ionic fluoride intercalated graphite with a gallery height of 4.7 Å (T. Nakajima, M. Molinier, M. Motoyama, Carbon, 29 (3) 429 (1991)). Dahn et al. reported stage 2 (002) peaks with a gallery spacing of 4.5 Å (J. R. Dahn and J. A. Seel, J. Electrochem. Soc., 147, 899 (2000).).

The results show that there is intercalation of F anion within the graphite structure causing an increase in the c lattice parameter values. The crystal structure of the MWNF electrode charged to 5.3V may be described as a mixture of stage 2 and stage 3 phases with c parameters of 7.8 Å and 11.2 Å respectively. Also, the peak intensity and ratio of (002)-2 and (003)-3 plans led to C₁₈F.

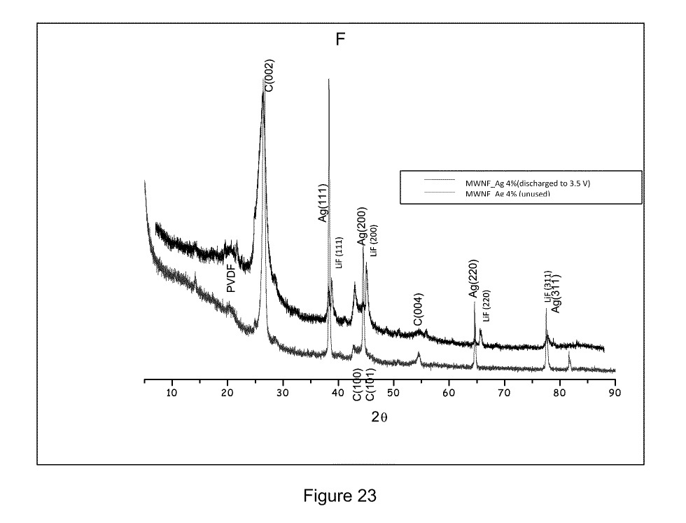

FIG. 23 compares XRD spectra of a film having the composition 75% MWNFs_Ag 4%+25% PVDF before use and after discharge to 3.5 V (chemically deposited film, Ag 4%).

XPS Measurements

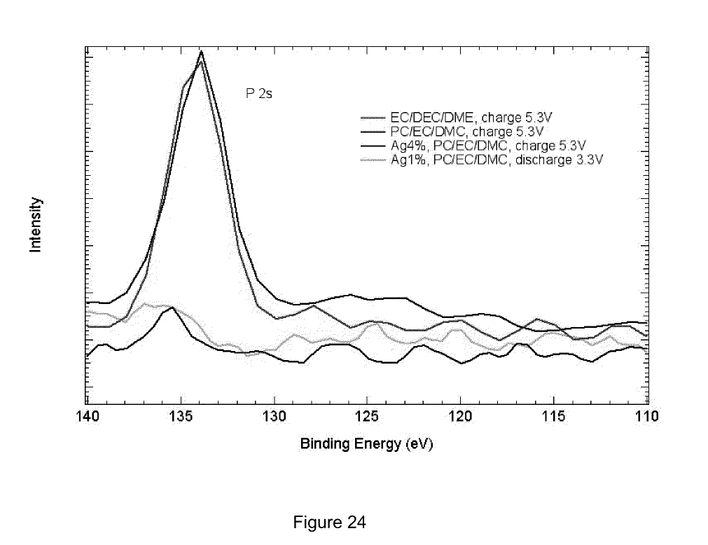

In order to verify that no other species than F— have been intercalated into MWNF, XPS measurements have been carried out on MWNF-based film cathodes after charging to 5.3V. FIG. 24 shows XPS patterns for various MWNF films used as cathode and charged to 5.3V. Upper two curves for cathodes with no silver, lower curve has Ag 4%. Only 2 cathodes exhibit the presence of phosphorous but these 2 films didn't undergo any washing after cycling and besides, the CV performed didn't exhibit any intercalation/deintercalation anion.

XPS measurements led to the conclusion that no PF₆⁻ has been intercalated.

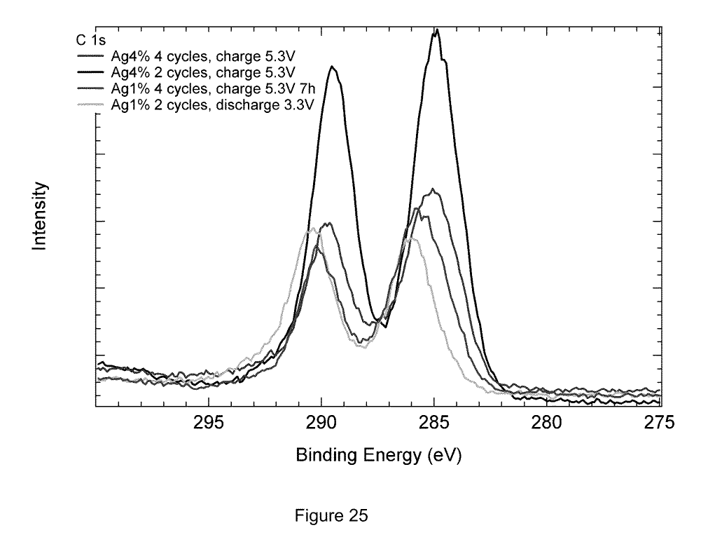

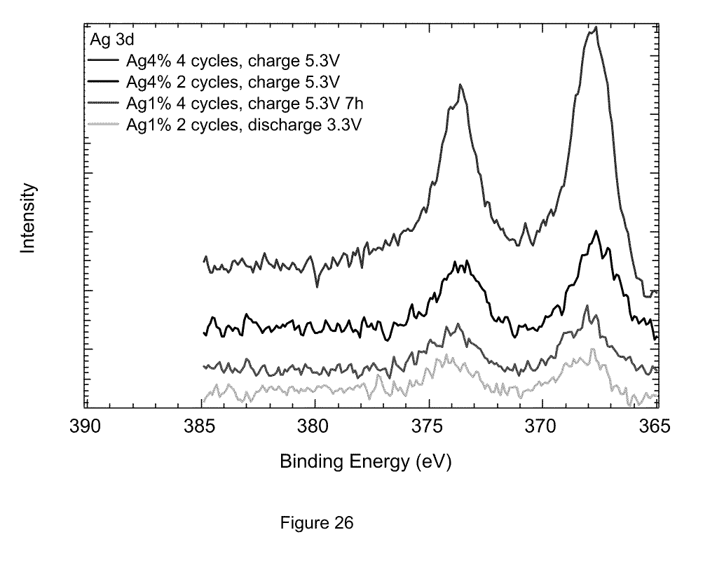

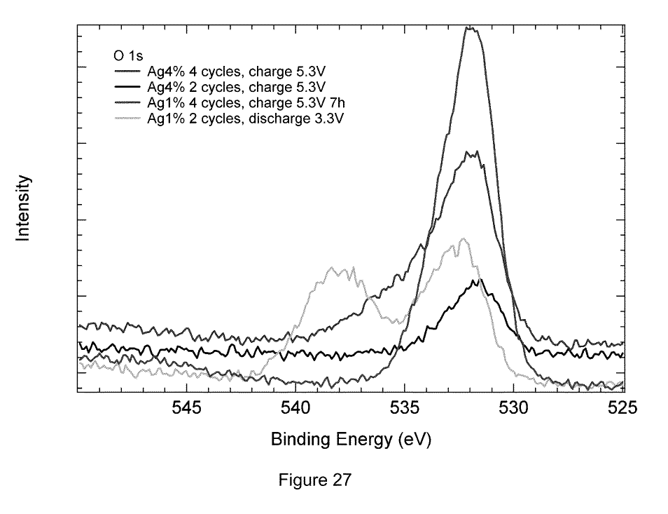

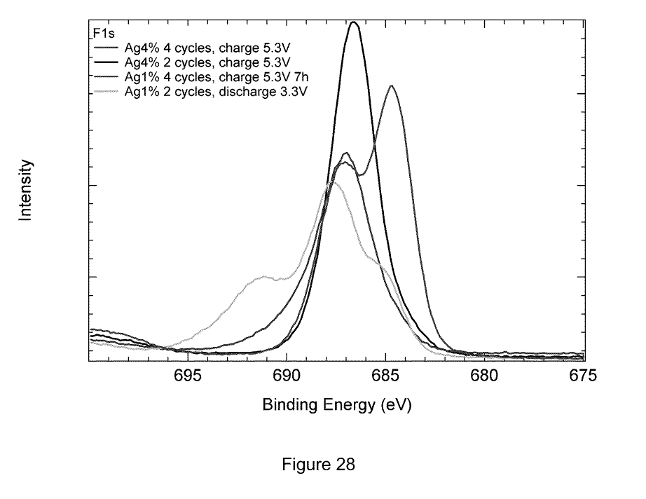

FIGS. 25-28 show XPS patterns for various MWNF films used as cathodes for the specified binding energy regions and testing conditions. FIG. 24 shows a minimal fraction carbon surface CF₂ or CF₃ (approximately 294 ev) except for Ag 1%, 2 cycles and relatively equal amounts of carbon covalently bound to fluorine (approximately 290 eV) and graphitic carbon (approximately 285 eV). Upper curve Ag 4%, 2 cycles. However, these results include the effect of binder in the film. FIG. 25 shows that Ag was present on each sample. In FIG. 26 the O 1s peak at 537.5 was only previously observed with electrodes soaked for three days. Upper curve Ag 1%, 4 cycles. In FIG. 27, the most ionic F peak (684.5 eV, LiF or AgF) was seen for the electrode held for 7 hours. The first observation of covalent CF₂ or CF₃ (approximately 693 eV) was with Ag 1%, 2 cycles. Upper curve Ag 4%, 2 cycles. However, these results include the effect of binder in the film.

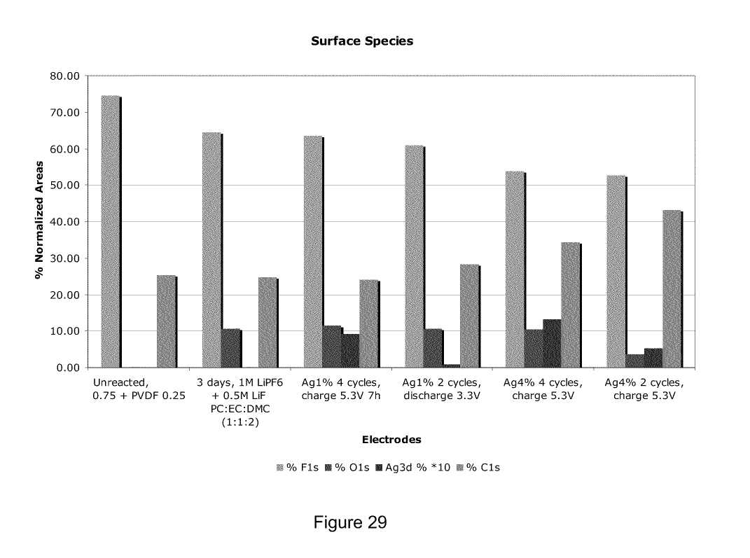

FIG. 29 shows surface species as identified from XPS patterns for the specified testing conditions.

We claim:

1. An fluoride ion (F⁻) host electrode for use in an electrochemical cell, the electrode comprising
a. an electrode mixture comprising
i) a plurality of carbon nanomaterials having a substantially ordered curved multilayered structure;
ii) a film or particles of a metal-based material deposited onto at least some of the nanomaterials;
iii) a polymeric binder material; and
b. a current collector
wherein at least a portion of the electrode mixture is in electrical contact with the current collector.

2. The electrode of claim 1, wherein the carbon nanomaterials are selected from the group consisting of multiwalled carbon nanotubes, multi-layered carbon nanofibers, multi-layered carbon nanoparticles, carbon nanowhiskers and carbon nanorods.

3. The electrode of claim 1, wherein the carbon nanomaterials are multiwalled carbon nanotubes or multi-layered carbon nanofibers.

4. The electrode of claim 1, wherein the carbon nanomaterials have been subjected to particle irradiation prior to their incorporation in the electrode mixture.

5. The electrode of claim 1 wherein the metal-based compound reacts with fluorine.

6. The electrode of claim 1, wherein the metal is selected from the group consisting of Cu, Ag, and Au.

7. The electrode of claim 1, wherein the metal is silver.

8. The electrode of claim 7, wherein the atomic ratio of silver to carbon is from 1% to 80%

9. The electrode of claim 8, wherein the atomic ratio of silver to carbon is from 1% to 40%.

10. The electrode of claim 1, wherein the metal-based material comprises a metal or metal alloy.

11. The electrode of claim 1, wherein the metal-based material comprises a metal salt.

12. An electrochemical cell comprising:
a) a first electrode comprising;
i) an electrode mixture comprising
a plurality of carbon nanomaterials having a substantially ordered curved multilayered structure;
a film or particles of a metal-based material deposited onto at least some of the nanomaterials;
a polymeric binder material; and
ii) a current collector
wherein at least a portion of the electrode mixture is in electrical contact with the current collector;
b) a second electrode;
c) a nonaqueous electrolyte provided between said first and second electrodes, said electrolyte being capable of conducting fluoride ions (F⁻);
wherein said first electrode reversibly exchanges said fluoride ions with said electrolyte during charging or discharging of said electrochemical cell.

13. The electrochemical cell of claim 12, wherein said electrolyte comprises a solvent and a fluoride salt, wherein said fluoride salt is at least partially present in a dissolved state in said electrolyte, thereby generating said fluoride ions in said electrolyte.

14. The electrochemical cell of claim 13, wherein said fluoride salt has the formula MFₙ, wherein M is a alkali metal or an alkaline earth metal.

15. The electrochemical cell of claim 14, wherein said fluoride salt comprises LiF.

16. The electrochemical cell of claim 12, wherein said first electrode is a positive electrode and said second electrode is a negative electrode.

17. The electrochemical cell of claim 16, wherein said negative electrode reversibly exchanges fluoride ions with said electrolyte during charging or discharging of said electrochemical cell.

18. A method for generating an electrical current, the method comprising the steps of:
a) providing an electrochemical cell according to claim 12; and
b) discharging the electrochemical cell.
